(19) United States
(12) Patent Application Publication
(10) Pub. No.: US 2011/0314534 A1
(43) Pub. Date: Dec. 22, 2011

(54) Secured Execution Environments and Methods

(76) Inventor: Lee James, Sparks, NV (US)

(21) Appl. No.: 13/087,355

(22) Filed: Apr. 14, 2011

Related U.S. Application Data
(60) Provisional application No. 61/324,115, filed on Apr. 14, 2010.

(51) Int. Cl. G06F 15/16; G06F 21/00

(52) U.S. Cl. 726/9

(57) ABSTRACT

A secured portable execution environment device could be provided by a business as a fee-based service, where a user selects applications that he wishes to license and methods of securing and backing up the execution environment. The device could be provided as a portable flash drive, which could then be plugged into any computer with any operating system to access the execution environment saved on the drive. When the user executes an application launcher on the flash drive and authenticates his identity, the application launcher allows the user to access secure applications saved on the flash drive and secure data saved in the application launcher environment.

This application claims priority to provisional application No. 61/324,115.

### FIELD OF THE INVENTION

The field of the invention is secured computing systems.

### BACKGROUND

In the market of portable computing, manufacturers can provide consumers with a myriad of different computing devices, for example cell phones, laptop computers, notebooks, tablets, and net-books. Unfortunately, a consumer can encounter numerous issues when interfacing with multiple computing devices, especially where each computing environment has a different, independent execution environment.

One problem stems from each computing device having a computing capacity that is more or less fixed at the time of purchase. After the purchase of a computer, the consumer has limited options to increase the computing power of the device. While a consumer could enhance the device by increasing the device's RAM memory or storage memory, a portable computer's processing power is generally fixed. When technological advances create a cost-effective opportunity for the consumer to purchase a computer having a greater computing capacity than the consumer's current computer, the consumer is faced with the dilemma of porting their current execution environment to the new, more advanced, computer.

Another problem with existing computing platforms includes ensuring that each computing environment is secured properly on an individual basis, especially where consumers use multiple computing devices to address various computing needs. For example, a consumer could use a cell phone to browse the Internet while traveling, use a work computer to access work related content, and then use a home computer to access personal content. Each device requires its own security authentication or authorization, which places an undue burden on the consumer to remember multiple usernames and/or passwords to access each computing device separately. A consumer might decrease their burden by using the same username and password on all computing devices, but that would increase the risk of a security breach on the computing devices.

Yet another problem with existing computing environments is that consumers have no method of securely running private applications in the same manner on different computing devices, or on computing devices that they do not wholly control. For example, where a consumer wishes to use a PC in a library, that public PC retains a browser history or an accessed document history, both of which could be accessed by others to glean information on the consumer's computer activity. Such consumers might prefer to keep such historical information private.

Several solutions have been proposed to secure data accessed by a user on multiple computer environments. U.S. Pat. No. 7,395,436 to Nemovicher teaches a file container that stores encrypted data files, keys, audit trails, signatures, or user profile information that can be accessed by a public computer using a password known only to a secure user. U.S. Pat. No. 7,584,198 to Slade teaches a secure data set packaged within a secure file that could be accessed using an encrypted file index that would reveal secure data. US Publication No. 20090183254 to Franco teaches a portable session management device that could be used authenticate a user on a host computer. Nemovicher, Slade, and Franco, however, each require a local application on the public computer to open and manipulate the data in the file container, which could lead to a breach of data from the file container to the public computer.

The product MojoPac™ (see URL www.mojapac.com) allows a USB device to operate as a portable desktop across Windows XP™ computing devices. MajoPac™, however, lacks platform agnostic features that would allow a user to run the virtual desktop in a secure environment. A MojoPac™, however, requires the public host computer to be a Windows XP™ device and does not secure the USB device in a way that will prevent a thief that stole the USB device from using its data.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

What has yet to be appreciated is that a secure execution environment device could be produced capable of operating across multiple computing platforms in an operating system agnostic manner.

Thus, there is still a need for improved secured execution environment devices.

### SUMMARY OF THE INVENTION

The inventive subject matter provides apparatus, systems and methods in which a secured execution environment can be created, managed, and used. The secured execution environment is preferably contained in a portable storage device, such as a USB flash drive or a Firewire hard drive, so that the user could carry the execution environment around at all times. As used herein, a “portable” storage device is one that is less than 10 pounds and could be comfortably carried by a human hand with the palm-side facing towards the ground. Exemplary portable storage devices include USB flash drives, hand-held portable hard drives, PDA devices, cell phones, and solid state disks. A secured execution environment device generally has a storage device that could include a secured/unsecured container for secure user data, one or more applications, and/or a secure application launcher, which are all preferably accessed by a user by coupling the secured execution environment to a host computing system via a computing host interface. Host interfaces include wired and wireless ports, and even include networks such as the Internet. Exemplary wired host interfaces include USB, Ethernet, PCI, Firewire, eSATA, or other wired technologies that can communicatively couple the storage device to a host computer, while exemplary wireless host interfaces include 802.11, Zigbee, WiMAX, UWB, Wireless USB, or other wireless technologies.

It should be noted that while the following description is drawn to a secured execution environment coupled to a “computer system,” various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. As such, contemplated “computer systems” include stand-alone desktop workstations, laptops, or just user interface terminals coupled to remote processors and NAS devices. An exemplary computer system has at least a user interface, a processor running an operating system, and volatile memory for running applications from the secured execution environment. The host computer system could also comprise a remote application server, which could then be configured to have a mirrored local cache accessible by the remote application server.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used herein, the term “volatile memory” is intended to include memory that is erased when the host computer system is shut down or the operating system is interrupted somehow, such as when another user logs into the host computer system. Contemplated types of volatile memory include RAM, DRAM, SRAM, CAM, and virtualized non-volatile memory that is treated by the operating system as volatile memory, such as the virtualized memory used by current Windows® Operating Systems. As used herein, “non-volatile memory” is intended to include memory is computer memory that can retain stored information even when the host computer system is powered off or a user is not logged into the operating system. Contemplated types of non-volatile memory include flash memory, magnetic computer storage devices, optical disks, paper tape, and even punch cards. Data files, applications, or other types of data could be stored in one or more secured containers within a storage device's non-volatile memory. Users could then launch applications from the storage device where the application executes in volatile memory of a computing platform while more persistent application data could be stored within the secured container of the portable storage device.

Generally, after the user of the secured execution environment couples the portable execution environment device to the host computer system, the user authenticates access to the secured environment using a user authentication token. This token could be any token suitable to authenticate the user, such as an alphanumeric password, a voice authenticated spoken phrase, a fingerprint, a key file, a retina scan, or a public/private key. The token could be entered through a user interface on the host computer or could be entered directly into the secured execution environment device itself before or after the device is coupled to the host computer system. Where the authentication token comprises biometric information, such as a fingerprint scanner, a retina scanner, or a face recognition althorithm, the biometric scanner could be located on the execution environment device itself, or on the host computer.

Another aspect of the invention includes a non-user authentication token that could be used to gain access to the secured execution environment, or could be added as an additional security precaution. The non-user authentication token could be, for example, an ID of the secured execution environment device, such as a USB flash drive serial number or a device number for a portable hard drive.

In an exemplary embodiment, the host computer accesses the secured execution environment has a mountable volume like any other computer-coupled storage device, and allows the user to execute the secured application launcher through the host computers user interface. Since mountable volumes generally lack the capability to internally execute any of the applications, the secured application launcher is generally loaded into the volatile memory of the host computer when the user executes the application launcher. The secured application launcher could then ask the user for their token before the user can access secure information in the environment. Once a user is properly authenticated with respect to the secured execution environment, the application launcher can configure the host computer to execute one or more of the applications in a volatile memory of the host computer white accessing application data or files stored within the secured container of the secured execution environment.

The secured execution environment is preferably configured to execute a secured application launcher for a plurality of host computer environments. For example, the execution environment device could include one or more virtual machines, emulators, or other types of operating system adaptors to allow an application to execute across different platforms. In another embodiment, the secured execution environment has a plurality of virtual machine executables, each one of which can open a common session environment. For example application launcher could execute in a Windows®-compatible executable, another could execute in an OS X®-compatible executable, and yet another could execute in a RedHat®-compatible executable. A single platform-independent module could also be launched before executing the secured application launcher, or as part of the secured application launcher, such as WINE^{HQ}, which allows Windows®-based applications to execute in Unix-based environments.

Through the secured application launcher, the user could then launch one or more applications saved in the non-volatile storage memory of the execution environment device on the host device by loading the applications in the volatile memory of the host computer, and preferably uses those applications to manipulate data in the secured container. In one embodiment, the secured application launcher only allows the user to manipulate data in the secured container via applications installed on the execution environment device, ensuring that the host computer never gains direct access to data in the secured container through an application running on the host computer. In another embodiment, some of the files in the secured container or some of the applications are encrypted, and are either automatically decrypted by the secured application launcher, or are individually decrypted through a second authentication token entered by the user. The applications could be especially configured to encrypt files when they are saved to a secured container, decrypt files when they are read from a secured container, and not encrypt files when they are saved to an unsecured container.

The container for files could be partitioned into a secured container that is only accessible after the application launcher authenticates the user or through another authentication program, and an unsecured container that is accessible to any user that couples the execution environment device to the host computer. The application launcher be configured to allow the user to save a file to the unsecured container for non-authenticated users, or simply for quick access to unsecured data. Either the secured or the unsecured container could be nested within other containers, and the secured container could comprise a hidden folder. With such an embodiment, a thief who plugs a stolen execution environment device in a host may only see an unsecured folder if the thief's computer settings are not set to show hidden files.

The application launcher could be configured to present a configuration user interface, or preferably a separate host computer could have a configuration application installed to assist the user in configuring the execution environment device. Another aspect of the inventive subject matter could include providing methods and services for configuring exemplary execution environment devices and maintaining the exemplary execution environment device, possibly as part of a for-fee service. In a preferred embodiment, a user could access the configuration user interface through a configuration interface hosted by a remote configuration server as part of a setup for the device prior to purchase. The user could select one or more options reflecting a desired configuration of the device, possibly including applications, types of application launchers, operating systems that the application launcher could execute within, authentication tokens, preferences, or other configuration attributes. In an exemplary embodiment, the configuration interface could scan the user's local computer for applications already installed, and could offer a discount on applications that the configuration server could verify as being “purchased” by the user, for example by verifying a license key used to register the application.

Once the user has selected a preferred configuration for the execution environment device, the configuration service could cause the selected options to be stored in a non-volatile memory of the execution environment device and could then configure the application launcher on the device to launch various applications based on the configuration attributes. Preferably, the storage device is also provisioned with one or more secured and/or unsecured containers for saving the applications and/or files. Each selected application could be placed within a hierarchical file structure having a limited separation between directories, and are preferably separated by no more than two directories. The configuration server could then configure the execution environment device to allow the user to launch applications from the storage device, assuming proper authentication. The application launcher could configure a host computer to execute the applications within a volatile memory of a host computer while accessing application data files from the secured container on the storage device.

When the secured container is accessed by a user, the application launcher could send a notification to a remote tracking server to indicate that the execution environment device is in use. In this way, if a thief happens to access the device, a user could access the remote tracking server to find out whether the thief has accessed the device, and could find an IP address of the host computer used to access the execution environment device. In an exemplary embodiment, the user could inform the tracking server to send a command back to the application launcher to delete some of the contents in the execution environment device the next time the tracking server is pinged by the stolen device.

In another embodiment, the tracking server could copies the data files in the execution environment device to a remote storage unit, essentially mirroring the data in any of the secured or unsecured containers. The tracking server could synchronize the application data files with a remote application server where the applications on the execution environment device need updating.

One should appreciate that the disclosed techniques provide many advantageous technical effects including allowing a consumer to have a single, secured computing environment device capable of launching applications on multiple computing devices. Such a secured execution environment device provides a single secured interface across the multiple devices thus eliminating a need for a consumer to remember multiple usernames or passwords. Additionally, the environment device could ensure that all data files are stored within a secured persistent container (e.g., a file system, directory, volume, etc.) that can only be accessed once proper authentication or authorization is granted. Still further, a user having such an environment could literally plug the environment in any computing device to gain access to the device's computing capacity in support for running various applications.

Various objects, features, aspects and advantages of the inventive subject matter will become more apparent from the following detailed description of preferred embodiments, along with the accompanying drawing figures in which like numerals represent like components.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable media. For example, a server can include one or more computers operating as a web server, database server, or other type of computer server in a manner to fulfill described roles, responsibilities, or functions. One should appreciate that the disclose techniques provide advantageous technical effects including platform independence for an execution environment or securing user data.

### BRIEF DESCRIPTION OF THE DRAWING

FIG. 1 is a schematic of an exemplary device in accordance with the current invention.

FIG. 2 is a schematic of the device and host computer of FIG. 1 coupled with a remote server and database.

FIG. 3 is a schematic of an exemplary client connected to a configuration server to create an execution environment device.

FIG. 4 is an exemplary user interface for an application launcher in accordance with the current invention.

FIG. 5 is a schematic of a method of opening and launching an application using an embodiment of an application launcher.

FIG. 6 is an exemplary task manager that manages an execution environment.

FIG. 7 is a hierarchical file structure for applications

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

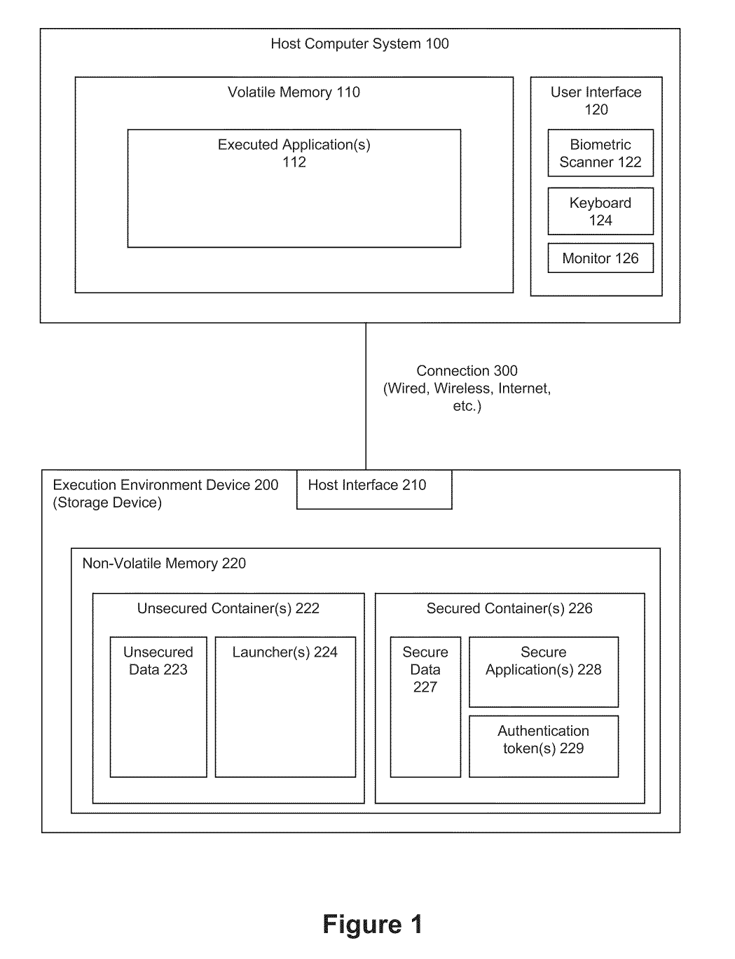

FIG. 1 provides an overview of an exemplary execution environment device 200 coupled to host computer system 100 via connection 300. Preferably, the execution environment device 200 includes non-volatile memory 220, represented here euphemistically as a USB-based flash drive. However, other storage devices could also be leveraged including hard disk drives, solid state drives, cell phones, media players, or other devices having non-volatile memory. Although the storage device preferably comprises flash memory, other persistent memories can also be used, including magnetic media, optical media, MRAM, race-track memory, or other forms of persistent memory.

Preferably execution environment device 200 comprises one or more regions of non-volatile volatile memory 220 allocated to containers, such as unsecured container 222 and secured container 226. Containers could be configured to be secured where all data residing in the container remains encrypted. Such an approach provides privacy for a user should the storage device become lost or stolen. For example, one could define a container using any suitable technique possibly based on TrueCrypt (see URL www.truecrypt.org) or FreeOTFE (see URL www.freeotfe.org) technologies. One should also appreciate that containers could be nested within each other or even hidden from view. In a preferred embodiment, secured container 226 is nested within a hidden folder so that a normal user would not be able to browse to find secured container 226. Providing such configurations allows users to nest security layers as desired or create a reasonable case of plausible deniability.

Non-volatile memory 220 stores data in an unsecured container 222, which could contain unsecured data 223 and one or more application launchers 224, and a secured container 226 that could have secure data 227, one or more applications 228, and one or more authentication tokens 229. A secured or unsecured container is considered to be defined regions of memory where data could be stored, whether that data be an application launcher, applications, or data files. Contemplated containers could take many different forms including a file, a mounted volume, a block of memory, or other structures capable of storing and retrieving data.

Application launcher 224 represents software instructions capable of configuring host computer 100 to load and execute one or more applications 228. Application launcher 224 could take any form to launch applications from the security container. For example, application launcher 224 could be an executable that mounts the secured container to the host computer system 100, or application launcher 224 could be a virtualized computer system that saves a current computer session in secured container 226. Application launcher 224 could be a single executable file that runs on multiple platforms or could be a plurality of executable files, each one designated to run on a separate platform type. Application launcher 224 preferably ensures that host computer 100 executes application 112 in host computer system 100's volatile memory 110, while storing application data files in non-volatile memory 220, preferably secured container 226.

Application 228 could include any desired type of application. Contemplated applications that could be deployed within a contemplated environment device include productivity apps, communications apps, web browsers, and games. An executed application 112 could be set to encrypt and save secure data 227 generated from executed application 112 to secured container 226 as an encrypted file, or could save unsecured data 223 generated from executed application 112.

Generally, executed environment device 200 is coupled to host computer system 100 through host interface 210 and connection 300, which is preferably a wired USB connection, but could be any other functional computer connection without departing from the scope of the invention. Host computer system 100 has a user interface 120 with a biometric scanner 122, keyboard 124, and monitor 126. Through user interface 120, a user (not shown) could access unsecured data 223, and could execute application launcher 224, which would then ensure that the platform and/or user has proper authentication or authorization access for the secure application 228 and/or the secure data 227.

Generally, application launcher 224 could authenticate the user and/or the execution environment device through one or more authentication procedures saved in authentication token(s) 229. For example, application launcher 224 could check the authentication token 229 for a key file, such as a USB serial number for execution environment device 200, to ensure that the data was not copied from the original USB to be mirrored on a duplicate, counterfeit USB. The application launcher 224 could also ask the user to input an alphanumeric password through the user interface, and could use biometric sensor 122 to scan biometric information from the user, such as a fingerprint or a retina print. Other known authentication procedures could be used without departing from the scope of the current invention.

Once the user has been properly authenticated by the application launcher 224, the application launcher could enable the user to execute secure applications 228 in the host computer's volatile memory 110 temporarily, and access secure data 227. In a preferred embodiment, as executed application 112 saves data to execution environment device 200, application launcher 224 encrypts the data to form secure data 227 in secured container 226, and decrypts that data when opening such a file. The user could, of course, designate that data saved by executed application 112 is saved as unsecured data 223 in unsecured container 222, or could decrypt a portion of secure data 227 and move it to unsecured data 223 in unsecured container 222.

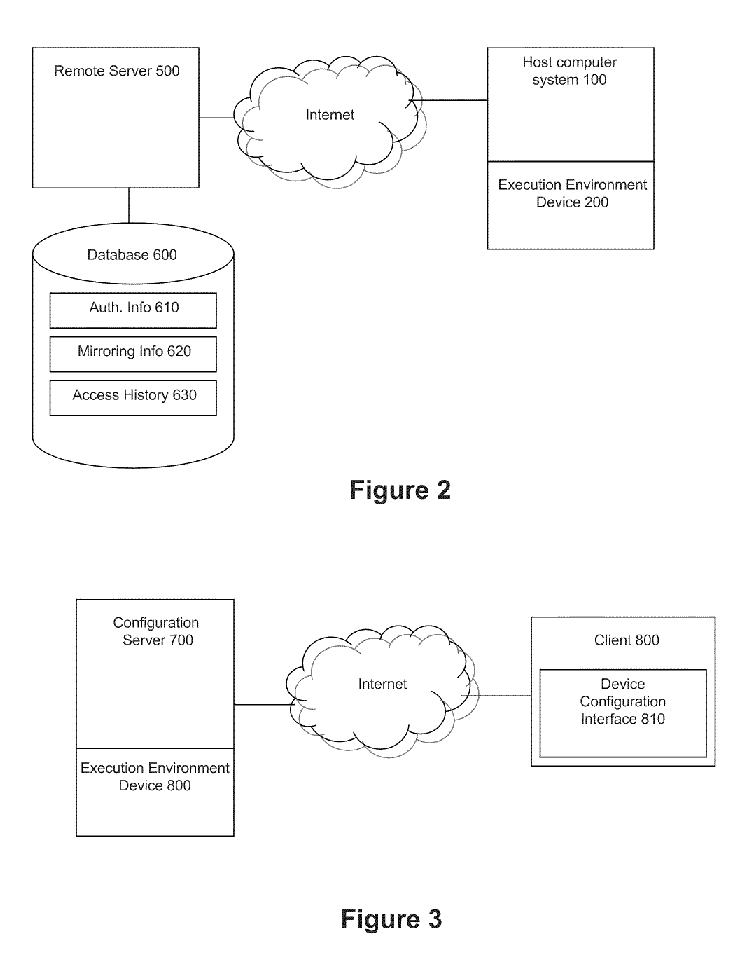

Additional embodiments can include further security measures that aid in ensuring only authorized users are able to access data within the storage device, shown in FIG. 2. The host computer system 100 could be functionally connected to a remote server 500 coupled with database 600 that implements backup and security features. The following list presents exemplary additional security measures.

(A) Device 200 could can be configure with a location report facility that executes whenever application launcher 224 is executed. When a user inserts the device 200 into a host computer system, it could send its location (e.g., GPS coordinates, IP address, etc.) to remote server 500, which then stores that information in database 600 as access history 630. If the device is operating from an unexpected location, it could be shut down or remotely wiped to prevent unauthorized users from gaining access to secured data. A user who has had his execution environment device 200 stolen could contact remote server 500 to implement such administration tasks.

(B) Device 200 could be configured with a launching program encoded with a key saved either as authentication token 229, or on the remote database as authentication information 610. When initiated, the program could validate its keys, possibly based on a hash value, as a function of one or more secured values. For example, the key might include hash based on a checksum of the present applications, a user password, biometric data, user defined tokens, a secured device identifier, or other security information. The information could be stored in a secured authority file, (preferably no more than 500 bytes and more preferably no more than 300 bytes.

(C) Device 200 could be configured with a license manager to manage licenses of applications 228. The license manager could determine which applications, features, or capabilities are available to the user assuming proper authentication. If desired, the user could purchase additional rights. The remote server 500 could track usage of the applications through access history 630, which could include information on how the user has been using certain applications, such as the number of hours, the number of times used, the number of files accessed by the application, etc. The license manager could then shut down the application remotely from remote server 500 if the user exceeds a license agreement, or could renew a license if a license expires.

(D) Device 200 could be configured to limit failed attempts at gaining access. Should an unauthorized user fail to gain access to Device 200 after a set number of attempts, device 200 could lock out all attempts or even erase the memory of the device. Other forms of limitations are also contemplated including limiting number of sessions, limiting access to defined times, restricting location where device is used, restricting conditions in which the device is used, or other possible configurations.

(E) Device 200 could be configured to allow a user to select how the user wishes to run an application. The user could select running the application in an unsecured manner by having data files stored in an unsecured container, or even on a host computer. The user could also select to run the application within a secured container.

Execution environment devices could be minimal computation devices, lacking an ability to execute stored applications without a host computer. Preferably, the host computer executes the applications within its volatile memory.

It is also contemplated that the host computer could comprise a remote application server accessible over a network (e.g., the Internet, WAN, LAN, etc.). In such an embodiment, the execution environment device could include one or more containers that operate as a mirrored local cache accessible by the remote application server where connectivity to the remote server is required for local applications to execute. The mirrored local cache could allow local applications to execute when a connection is lost to the remote application server. Naturally, upon re-establishment of the connection with the remote application server, the mirrored local cache could synchronize with the remote application server. Such an application becomes practical through the security features of the execution environment device.

### Configuration of Execution Environment Devices

Execution environment devices, including those similar to the storage device of FIG. 1, could be configured through numerous methods. In some embodiments, the execution environment device could be purchased and configured through a for-fee service hosted by a configuration server. An exemplary method if shown in FIG. 3, where a purchasing user accessing a computer 800 is accessing configuration server 700 through the Internet and uses device configuration interface 810 to dictate the functionality of the purchased execution environment device 800.

Device configuration interface 810 could be any suitable interface that could communicate a user's wishes to configuration server 700. (e.g., web page, APIs, web services etc.) over a network connection, such as the Internet. The server could cause the configuration interface to be presented locally to the user if desired. Contemplated configuration interfaces provide a selection of one or more applications that could be stored on the execution device 800. Users select, purchase, configure, or otherwise determine applications of interest to be installed on the device 800.

To increase security of the device 800, users could also submit various security information including one or more authentication tokens (e.g., password, keys, biometric data, etc.) that could be used to the secure the device 800, containers, applications, or other features. Security information could represent configuration attributes that govern operation of the environment device 800. Example configuration attributes could include location criteria, ambient data criteria, biometric data, or other information.

Once a user has provided a desirable configuration of the device 800, the configuration server stores selected applications or tokens within the memory of the device 800. Furthermore, the configuration server could also configure an application launcher based on the user provided authentication token or other security information so that the device 800 will only allow the applications to execute upon proper authorization or authentication. The launcher could also be secured via a key file encoded with the user authentication token or other security information possibly comprising an environment identifier, dates, times, schedules, locations, ambient data collected at a location of the device 800, IP address, or other information stored or collected by the device 800.

Although more preferred embodiments provide for a platform agnostic device, it is also contemplated that execution environment devices could be bound to a specific computing platform. Users, possibly including corporate entities, might wish to restrict devices to a Linux-based platform or a Windows®-based platform.

A secured container could also be established within a region of memory of the device 800, possibly based on the one or more pieces of security information as discussed above. In some embodiments, the secured container could be encrypted, hidden, nested within other containers, or otherwise secured from access unless access has been authorized or a user has been authenticated.

When the device 800 is suitably configured, a user could be allowed to access the application launcher to execute one or more of the applications. For example, in an embodiment where the device 800 comprises a USB device having non-volatile memory (e.g., flash, HDD, SSD, etc.), the user could insert the device 800 into a suitable connector of a host computer. When the user accesses device 800 via the computer, device 800 could require user authentication before allowing the user to access the application launcher. Once the user is authenticated, the application launcher could present the user access to the applications. A selected application could be launched by executing the application in the volatile memory of the computer while application data could be stored in a secured container, thus ensuring privacy of the user's data.

Contemplated execution environment devices could also be logically incorporated into a host computing system. For example, the device itself or regions of its memory could be mounted as a drive or volume on the host computer. Each section of memory could also be mounted as a separate volume, including mounting the secured container as a volume. As data is accessed on the volume of the secured container, the application data could be encrypted or decrypted according the configured security measures of the device.

The memory of the device could be arranged according to nearly any organizational scheme to access data. A preferred approach includes storing applications in a manner where application data files are separated from each other by a minimized number of directories. Minimizing the directory separation improves performance of the system and reduces application launching latency. More preferred devices utilize a hierarchical file structure having no more than two directories separating application data files. Preferably the configuration server creates such a file organization when configuring a device.

When devices are suitably configured according to the user's instructions, the devices could be given to a user. As discussed previously, when the user accesses a device or one of the device's secured containers, the device could send a notification to a tracking server. The notification could include a device identifier, a location, a time stamp, an IP address of a host computer, collected ambient data (assuming access to appropriate sensors), or other notification information.

### Example Embodiment

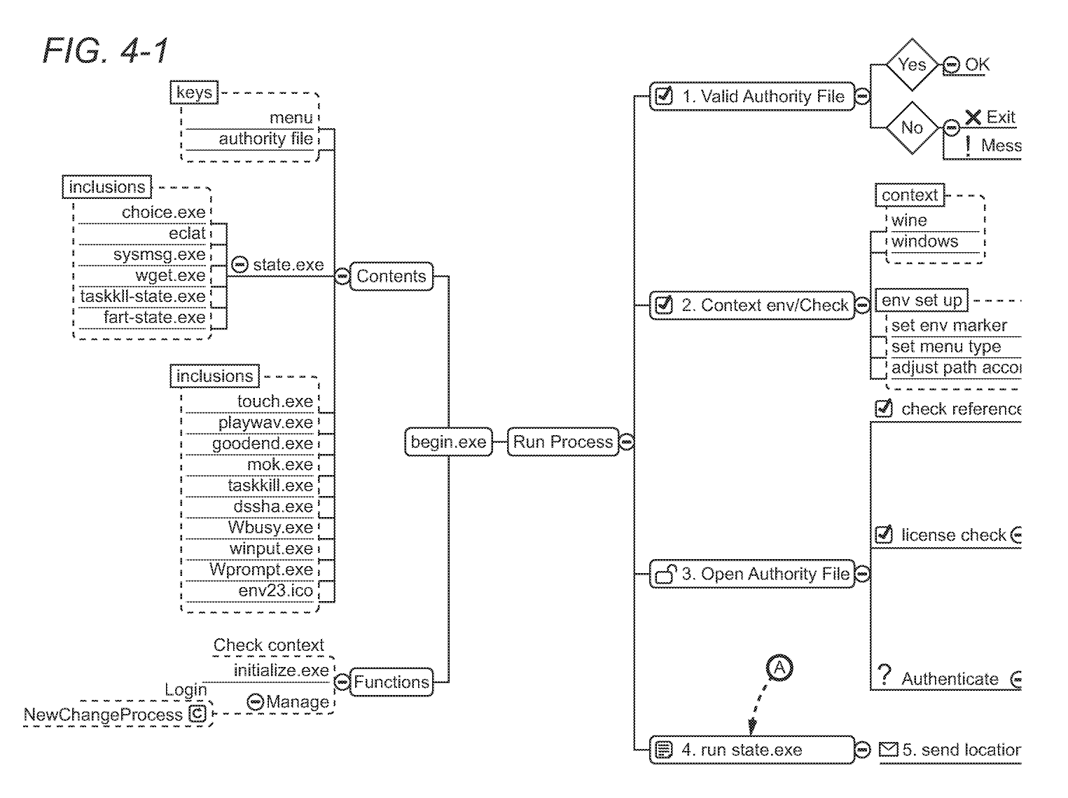

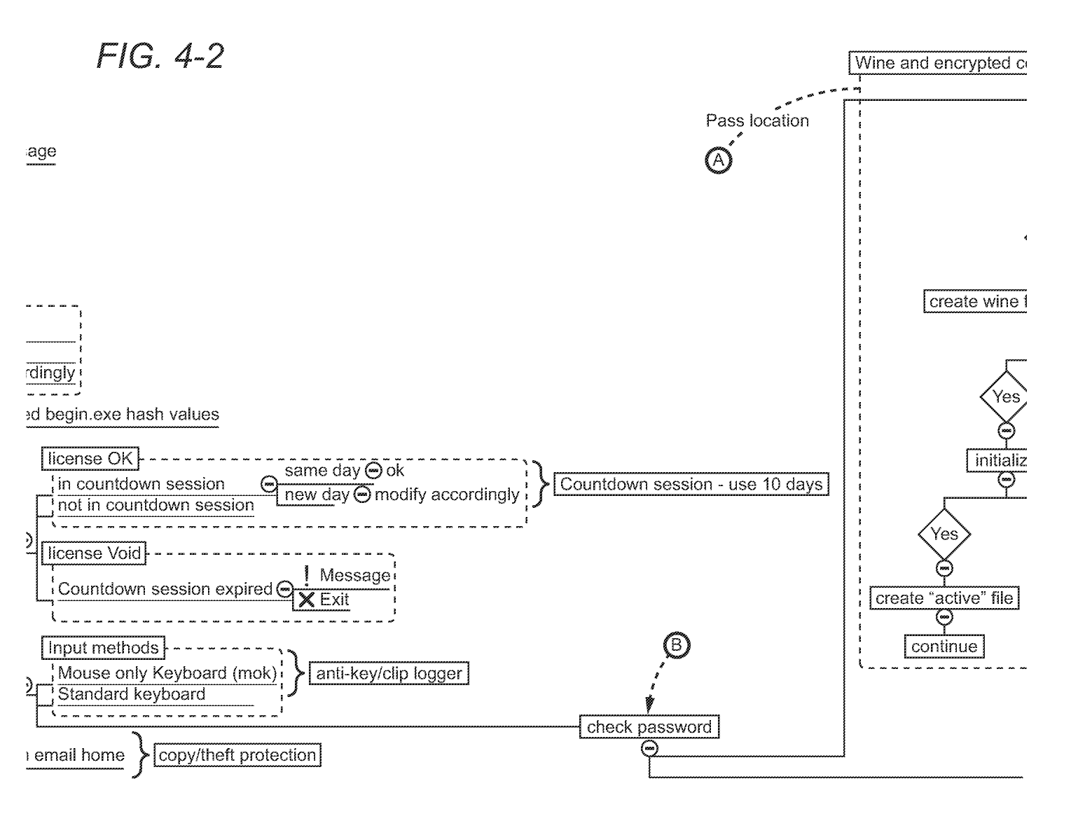

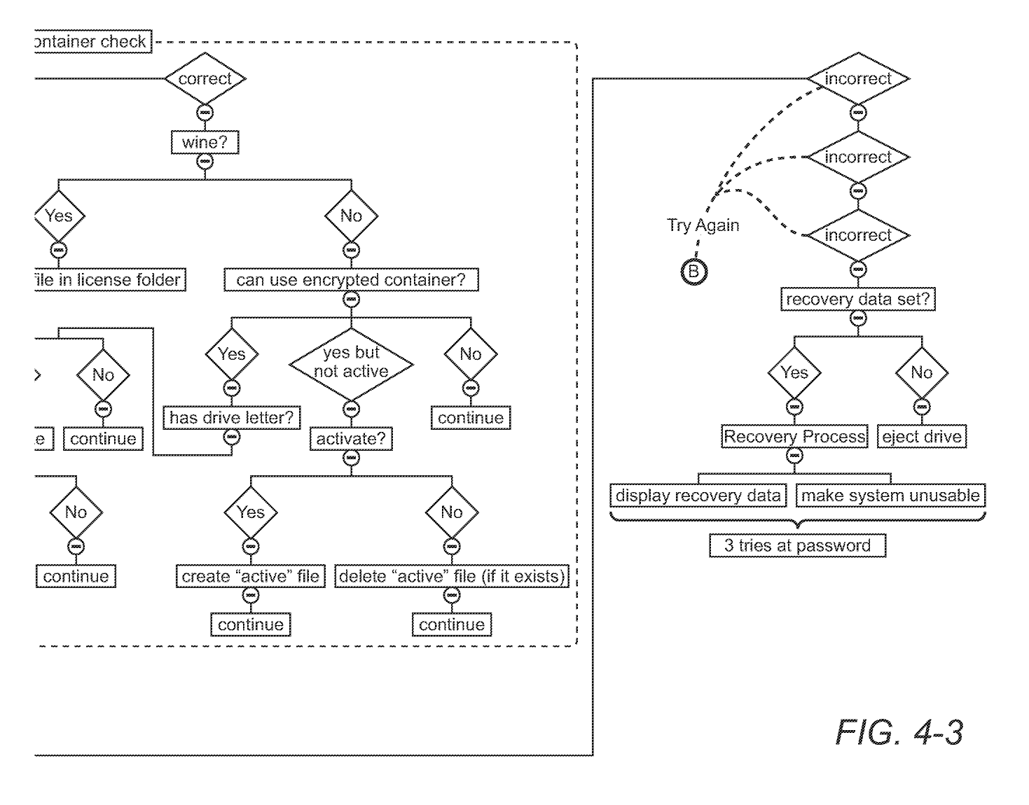

FIGS. 4 through 7 present a possible architecture and logic flow for a secured execution environment device. The presented architecture represents a model for a USB-based flash device.

In FIG. 4 program begin.exe represents a starting point from which a user gains access to an execution environment device. When user inserts the device into a host computer, program begin.exe executes in the volatile memory of the host computer. Several security checks could occur before allowing a user to launch an application. For example, an authority file (e.g., a key file) could be checked to ensure it is valid. The execution platform could be checked to determine how to present applications to a user via the host computer. The authority file could be opened and read to ensure the device is allowed to be used. As shown, begin.exe is checked against a hash value to validate that begin.exe has not changed. Other checks could include conducting a license check, determining a session count, checking for I/O devices, validating passwords, checking for encrypted containers, or performing other types of security checks. It is also contemplated that the device could send its location information to a remote tracking server.

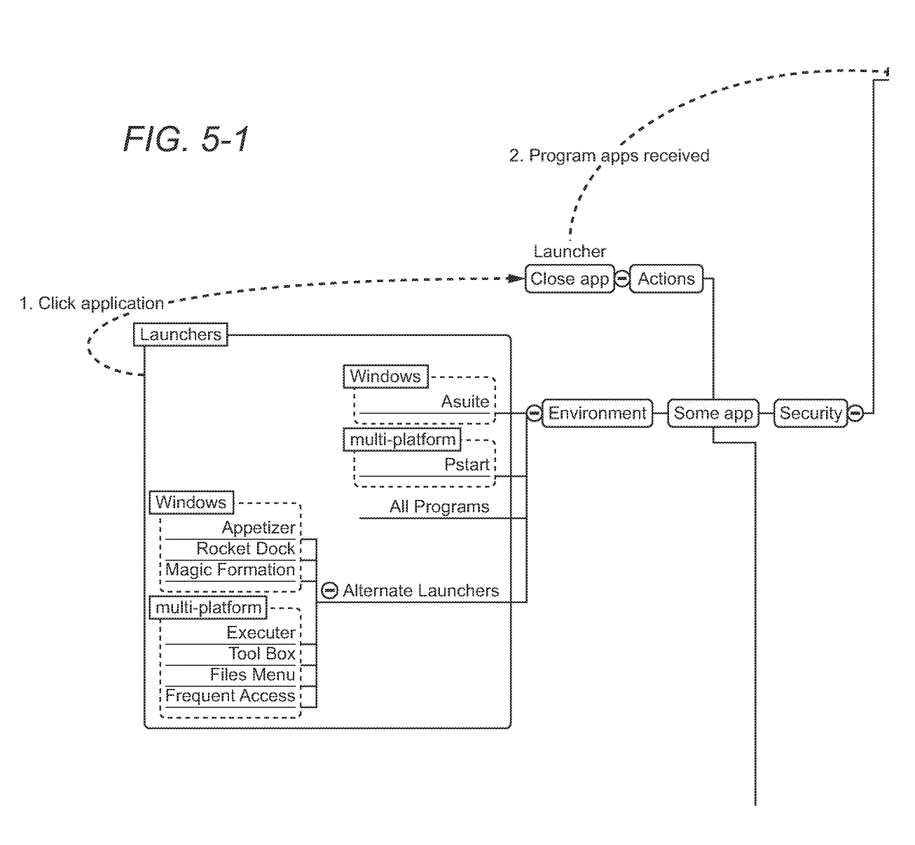

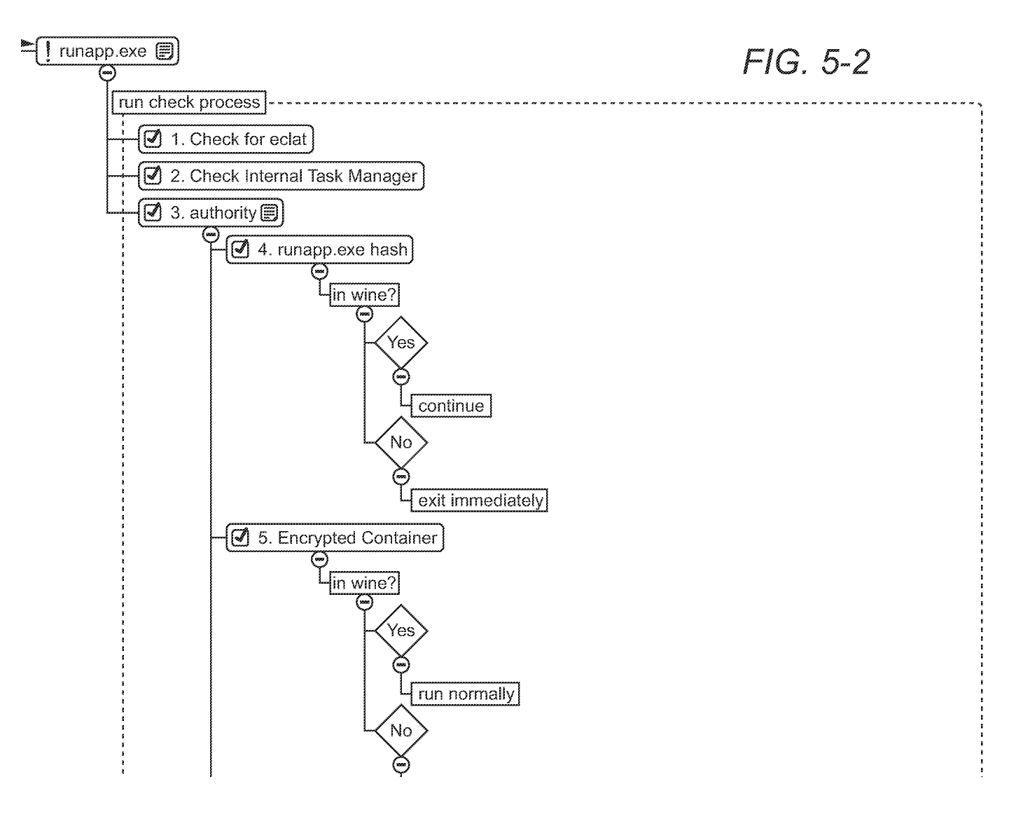

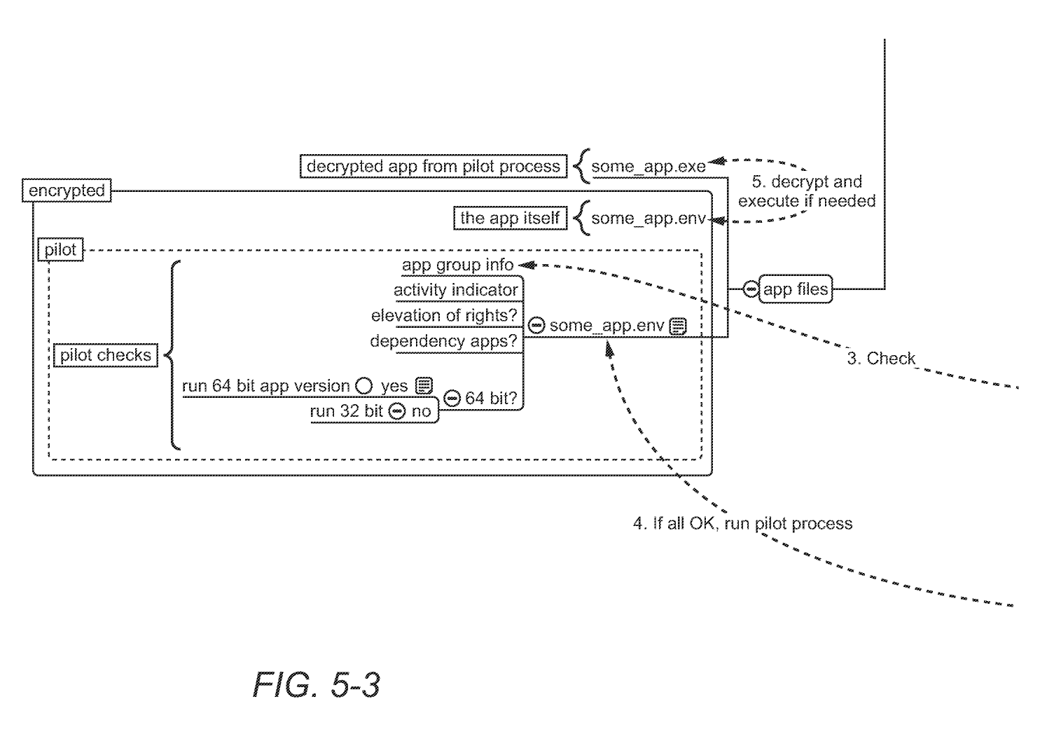

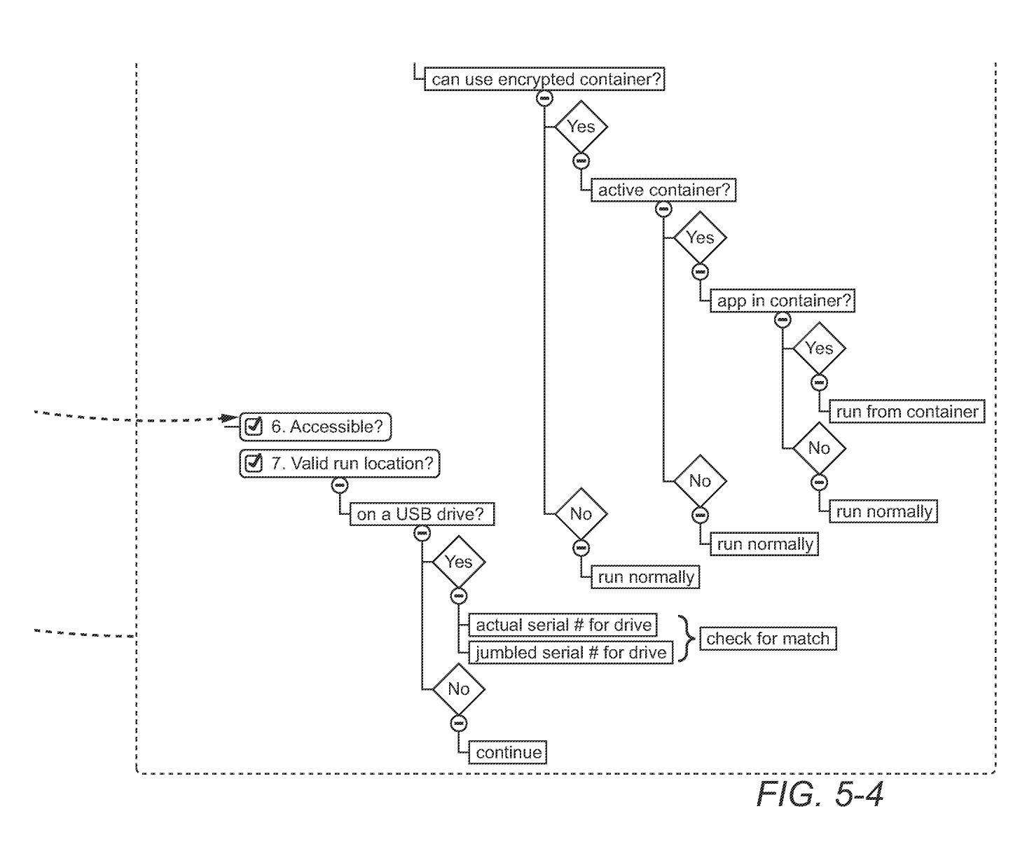

FIG. 5 presents an outline describing launching an application. For example, a program called runapp.exe could also conduct one or more security checks before launching the application. As shown, runapp.exe could validate itself against a hash, validate encrypted containers, validate the device's location, or perform other security checks. Assuming all security conditions are met, a pilot program could launch the application on the host computer as directed by the user.

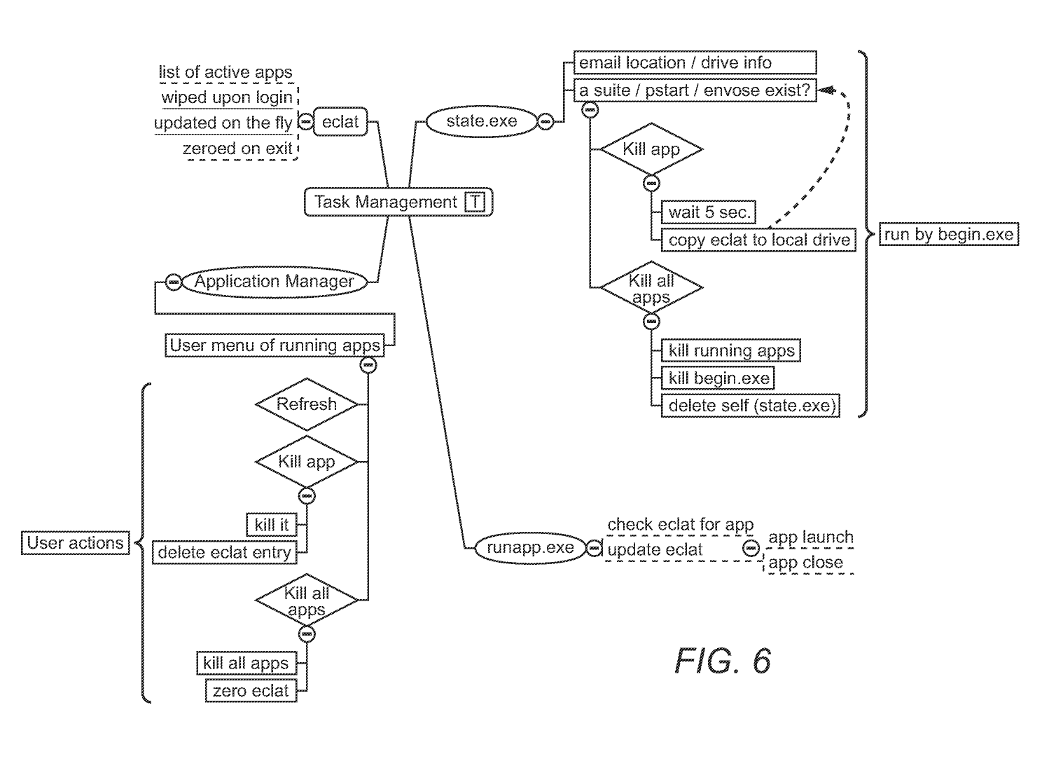

FIG. 6 presents an overview of a possible task manager that oversees the execution environment.

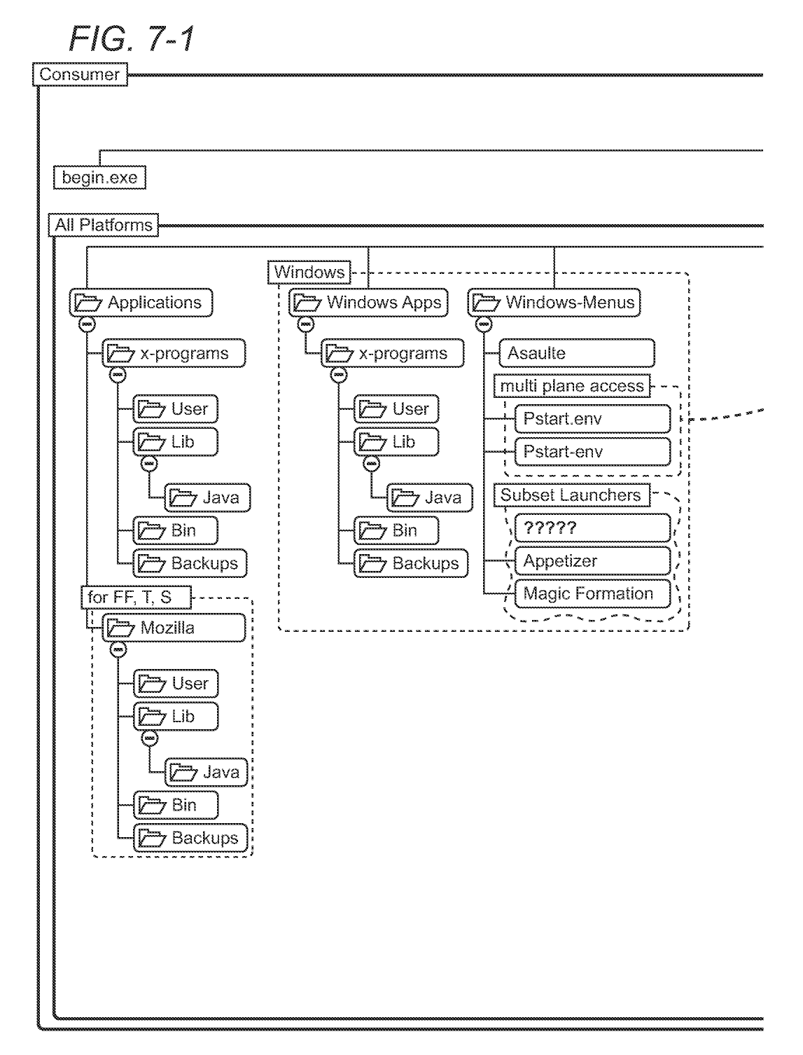

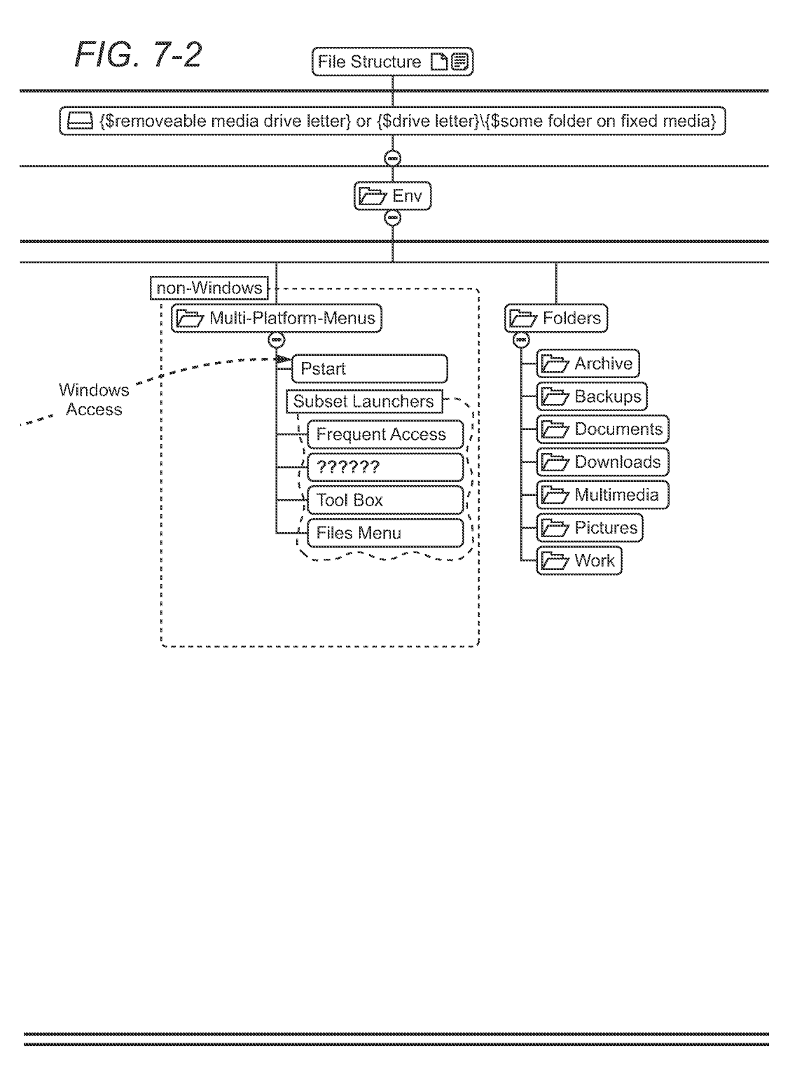

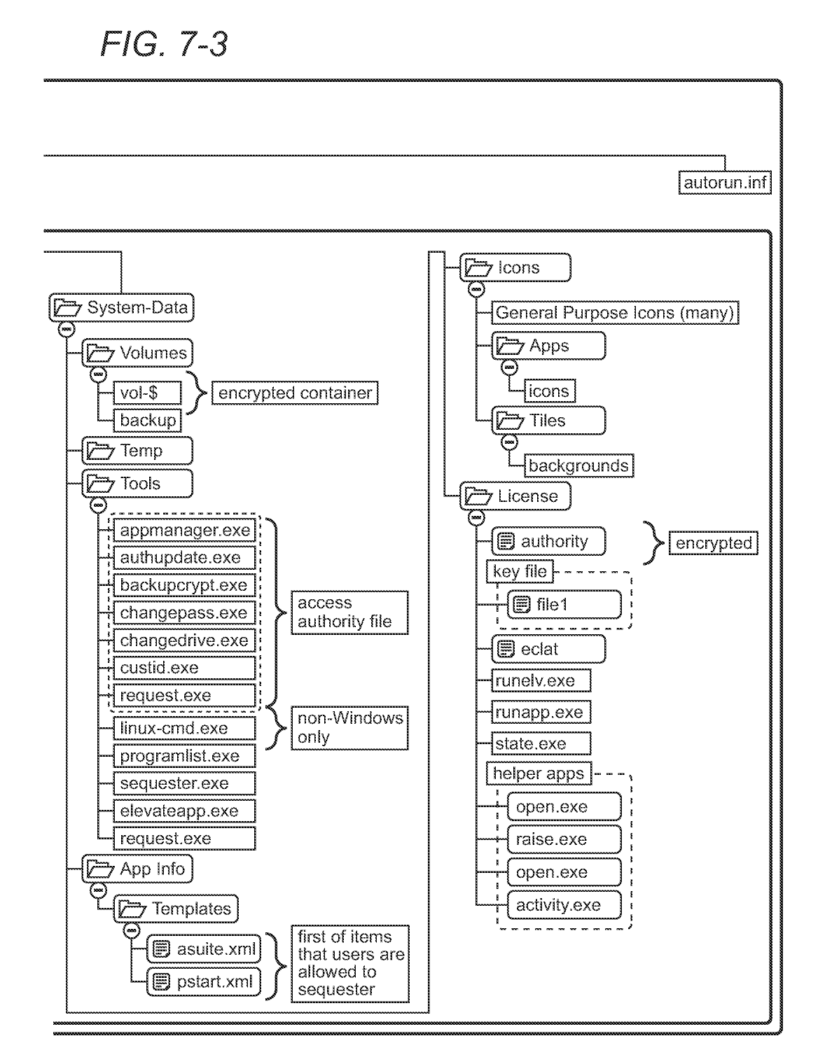

FIG. 7 presents an overview of a hierarchical file structure having limited separation of directories between application data files.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context in particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing a secured portable execution environment device, the method comprising the following steps:
providing a user with access to a configuration server;
using the configuration server to present a device configuration interface through which the user can (a) select a plurality of applications, and (b) submit a user authentication token;
using the configuration server to store the selected ones of the applications in a memory of the portable execution environment device, wherein the portable execution environment device has a computing host interface;
storing an application launcher in the memory;
establishing a secured container within the memory; and
using the configuration server to configure the application launcher to (a) allow launching of any one of the selected ones of the applications in a volatile memory of a host computer system coupled to the computing host interface, and (b) access the secured container through the computing host interface, when the user authenticates its identity via the user authentication token; and
providing the portable execution environment device to the user.

2. The method of claim 1, wherein the step of configuring the application launcher includes providing a key file encoded with the authentication token, wherein the key file is stored in the memory and is at least in part required for authentication.

3. The method of claim 2, further comprising encoding the key file with a unique storage device ID of the portable execution environment device.

4. The method of claim 1, further comprising mounting the secured container as a volume on the host computer system.

5. The method of claim 1, encrypting an application data file required to launch at least one of the plurality of applications as the application data file is stored within the secured container.

6. The method of claim 5, decrypting the application data file as the application data file is read by the application launcher.

7. The method of claim 1, wherein the step of storing the selected ones of the applications includes placing the selected ones of the applications into hierarchical file structure having a limited separation between directories.

8. The method of claim 7, wherein the directories of the file structure are separated from one other by no more than two directories.

9. The method of claim 1, further comprising sending a notification to a device tracking server to indicate use of the secured container.

10. The method of claim 9, wherein the notification includes at least one of an ID of the portable execution environment device, an IP address of the host computer system, and a time stamp.

11. The method of claim 1, further comprising mirroring the selected ones of the applications in the secured container with a remote application server.

12. The method of claim 11, further comprising synchronizing the selected ones of the applications with the remote application server when the user invokes the application launcher.

13. The method of claim 1, wherein the portable execution environment device comprises a memory device selected from the group consisting of: a flash drive, a solid state disk, a hard disk drive, and a cell phone.

14. The method of claim 1, wherein the device configuration interface allows the user to select a plurality of target platforms, and wherein the step of configuring the application launcher allows launching of the applications and the application launcher in any of the selected ones of the platforms.

15. The method of claim 1, wherein the step of configuring the application launcher includes providing a multi-platform application launching environment.

16. The method of claim 1, wherein the step of configuring the application launcher includes allowing the user to move one of the selected ones of the applications from the secured container to a non-secured container.

17. The method of claim 1, wherein the step of configuring the application launcher includes allowing the user to move a data file from the secured container to a non-secured container.

18. The method of claim 17, wherein the non-secured container resides in the memory.

19. The method of claim 1, wherein the step of establishing the secured container includes creating a nested container in the memory, wherein the selected ones of the applications reside within the nested container.

20. The method of claim 1, wherein the step of establishing the secured container includes creating a hidden container in the memory, wherein the selected ones of the applications reside within the hidden container.
